(19) United States
(12) Patent Application Publication
(10) Pub. No.: US 2024/0142364 A1
(43) Pub. Date: May 2, 2024

(54) LED SENSOR MODULE

(71) Applicant: Lumileds LLC, San Jose, CA (US)

(72) Inventor: Hisashi Masui, San Jose, CA (US)

(73) Assignee: Lumileds LLC, San Jose, CA (US)

(21) Appl. No.: 18/409,947

(22) Filed: Jan. 11, 2024

Related U.S. Application Data
(63) Continuation of application No. PCT/US22/37142, filed on Jul. 14, 2022.
(60) Provisional application No. 63/221,778, filed on Jul. 14, 2021.

(51) Int. Cl. G01N 15/075; G01N 15/0205

(52) U.S. Cl. CPC G01N 15/075; G01N 15/0205

(57) ABSTRACT

A sensor system comprises an LED arranged to emit light and to detect a portion of the emitted light that is scattered or reflected back to the LED. A sensing method comprises detecting with an LED light emitted by the LED and scattered or reflected back to the LED and determining a change in voltage-current characteristics of the LED resulting from detection of the scattered or reflected light. The sensor system and the sensing method may be used, for example, to determine properties of particles in a fluid into which the LED emits light or to determine the presence or absence of an object located between the LED and a reflective or scattering surface.

### CROSS REFERENCE TO RELATED APPLICATIONS

This application is a Continuation of International Patent Application PCT/US2022/037142 filed Jul. 14, 2022, which claims benefit of priority to U.S. Provisional Patent Application No. 63/221,778 filed Jul. 14, 2021. Each of these applications is incorporated herein by reference in its entirety.

### FIELD OF THE INVENTION

The present disclosure relates to LED sensor modules in which one or more LEDs is configured to both emit light and detect reflected or back scattered portions of the emitted light. These sensor modules may be used for detection of particle concentration in a gas or liquid, for example.

### BACKGROUND

Semiconductor light emitting diodes and laser diodes (collectively referred to herein as “LEDs”) are among the most efficient light sources currently available. The emission spectrum of an LED typically exhibits a single narrow peak at a wavelength determined by the structure of the device and by the composition of the semiconductor materials from which it is constructed. By suitable choice of device structure and material system, LEDs may be designed to operate at ultraviolet, visible, or infrared wavelengths.

LEDs can be used as light sources in sensor systems for use, for example, for particle detection in gas or liquid. Such sensor systems can be used for example for smoke detection, droplet density determination, or atmospheric, water or other fluid quality monitoring.

Conventionally, such sensor systems employ an LED as a light source and another semiconductor device (e.g. a photo diode) as a light detector. Unfortunately, manufacturing costs, needed supporting circuitry and power for two semiconductor devices can be significant. Lower cost particle detection systems that do not require two or more separate semiconductor devices as emitter and detector are needed.

### SUMMARY

This specification discloses sensor systems and methods that employ an LED as both a light emitter and a light detector. These systems and methods may be inexpensively employed to characterize particles in a fluid (e.g., determine particle size and/or concentration) or to determine the presence or absence of an object between the LED and a scattering or reflective surface.

In one aspect of the invention, a sensor system comprises an LED arranged to emit light and to detect a portion of the emitted light that is scattered or reflected back to the LED, and a processor configured to determine a change in voltage-current characteristics of the LED resulting from detection of the scattered or reflected light.

By processor is meant any suitable circuit or device that can determine whether a change in voltage-current characteristics of the LED has occurred and, optionally, the magnitude of the change. The processor may for example determine whether a change of current (e.g., at constant voltage) or a change of voltage (e.g., at constant current) from the detector has occurred. The processor may further determine the magnitude of such a change and, for example, whether such a change exceeds some predetermined threshold value. The processor may be or comprise, for example, an integrated circuit microprocessor or a simpler analog or digital circuit.

The LED may for example be one of two or more LEDs in an LED array with each of the two or more LEDs arranged to emit light and to detect a portion of the light it emitted that is scattered or reflected back to it. The processor may be configured to determine a change in voltage-current characteristics for each of the LEDs resulting from detection by each LED of scattered or reflected light.

The sensor may comprise a first LED and a second LED, with the first LED arranged to detect a portion of light emitted by the second LED that is scattered or reflected to the first LED in addition to detecting light that it emits and is back scattered or reflected to it. The second LED may for example be configured to emit amplitude modulated light, and the processor may be configured to detect an amplitude modulated signal from the first LED resulting from the portions of the light emitted by the second LED that are scattered or reflected to the first LED.

The sensor system may comprise a scattering or reflective surface arranged to scatter or reflect light emitted by the LED back to the LED. In such cases, the amount of light reflected or scattered back to the LED by the surface may be reduced by the presence of scattering particles or a light-blocking or light scattering object located between the LED and the surface. In the absence of such a scattering or reflective surface, the amount of light reflected or scattered back to the LED may be increased by the presence of such light scattering particles or object.

The LED may be arranged to emit light into a chamber and to detect a portion of the light emitted into the chamber that is scattered or reflected back through the chamber to the LED. The chamber may have, for example, a hemispherical, spherical, or parabolic shape and may be open or closed with respect to a surrounding environment. The processor may be configured to determine properties (e.g., sizes or concentrations) of particles in a fluid in the chamber from the change in voltage-current characteristics of the LED that results from detection of the light scattered or reflected back through the chamber to the LED. In such variations the sensor system may comprise a scattering or reflective surface arranged to scatter or reflect light emitted by the LED into the chamber back through the chamber to the LED. The scattering or reflective surface may form at least a portion of an inner surface of the chamber. In some variations at least a portion an inner surface of the chamber is configured to absorb light emitted by the LED into the chamber. The sensor system may comprise an optical element arranged to collimate the light emitted by the LED into the chamber and to focus onto the LED light reflected or scattered back to the LED.

In another aspect of the invention, a sensing method comprises detecting with an LED light emitted by the LED and scattered or reflected back to the LED and determining a change in voltage-current characteristics of the LED resulting from detection of the scattered or reflected light. The method may comprise determining properties (e.g., sizes or concentrations) of particles in a fluid into which the LED light is emitted from the change in voltage-current characteristics of the LED resulting from detection of the light scattered or reflected back to the LED. The method may comprise determining the presence or absence of an object located between the LED and a reflective or scattering surface from the change in voltage-current characteristics of the LED resulting from detection of the light scattered or reflected back to the LED. The method may comprise collimating the light emitted by the LED before it is scattered or reflected back to the LED. The method may, for example, employ any of the variations of the sensor system summarized above.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a schematic cross-sectional view of an example LED.

FIGS. 2A and 2B show, respectively, cross-sectional and top schematic views of an array of LEDs.

FIG. 3A shows a schematic top view of an electronics board on which an array of LEDs may be mounted, and FIG. 3B similarly shows an array of LEDs mounted on the electronic board of FIG. 3A.

FIG. 4A shows a schematic cross-sectional view of an array of LEDs arranged with respect to waveguides and a lens. FIG. 4B shows an arrangement similar to that of FIG. 4A, without the waveguides.

FIG. 5 schematically illustrates an LED sensor that both emits and detects light passing through a chamber.

FIG. 6A schematically illustrates an LED sensor that both emits and detects light passing through a hemispherical chamber.

FIG. 6B schematically illustrates an LED sensor that both emits and detects light passing through a spherical chamber.

FIG. 7 schematically illustrates an LED sensor that both emits and detects light passing through a parabolic chamber.

FIG. 8 schematically illustrates a LED sensor that both emits and detects light to provide low-cost identification of sensor occlusion by a moving object.

FIG. 9 schematically illustrates operation of a sensing system using an LED sensor that both emits and detects light passing through a chamber.

FIG. 10 is a graph showing an example LED sensor sensitivity to detected blue light.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention.

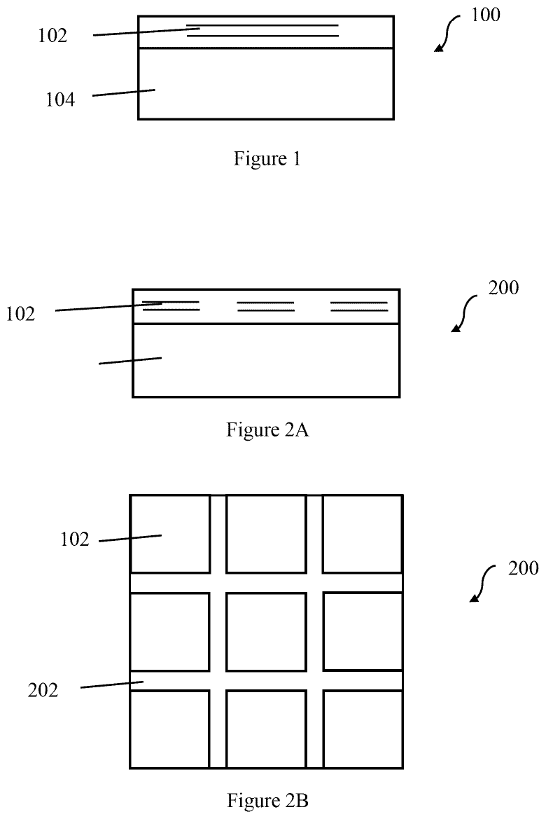

FIG. 1 shows an example of an individual LED 100 comprising a light emitting semiconductor diode (LED) structure 102 disposed on a substrate 104. Light emitting semiconductor diode structure 102 typically comprises an active region disposed between n-type and p-type layers. Application of a suitable forward bias across the diode structure results in emission of light from the active region. The wavelength of the emitted light is determined by the composition and structure of the active region.

The LED may be, for example, a III-Nitride LED that emits ultraviolet, blue, green, or red light. LEDs formed from any other suitable material system that emit any other suitable wavelength of light, for example infrared light, may also be used. Other suitable material systems may include, for example, III-Phosphide materials, III-Arsenide materials, and II-VI materials.

FIGS. 2A-2B show, respectively, cross-sectional and top views of an array 200 of LEDs disposed on a substrate 202. Such an array may include any suitable number of LEDs arranged in any suitable manner. In the illustrated example the array is depicted as formed monolithically on a shared substrate, but alternatively an array of LEDs may be formed from individual mechanically separate LEDs arranged on a substrate. Substrate 202 may optionally comprise CMOS circuitry for driving the LED and may be formed from any suitable materials.

Although FIGS. 2A-2B show a three-by-three array of nine LEDs, such arrays may include for example tens, hundreds, or thousands of LEDs. Individual LEDs may have widths (e.g., side lengths) in the plane of the array of, for example, less than or equal to 1 millimeter (mm), less than or equal to 500 microns, less than or equal to 100 microns, or less than or equal to 50 microns. LEDs in such an array may be spaced apart from each other by streets or lanes having a width in the plane of the array of, for example, hundreds of microns, less than or equal to 100 microns, less than or equal to 50 microns, less than or equal to 10 microns, or less than or equal to 5 microns.

LEDs having dimensions in the plane of the array (e.g., side lengths) of less than or equal to about 50 microns are typically referred to as microLEDs, and an array of such microLEDs may be referred to as a microLED array.

Although the illustrated examples show rectangular LEDs arranged in a symmetric matrix, the LEDs and the array may have any suitable shape or arrangement and need not all be of the same shape or size. For example, LEDs located in central portions of an array may be larger than those located in peripheral portions of the array. Alternatively, LEDs located in central portions of an array may be smaller than those located in peripheral portions of the array.

All LEDs in an LED array may be configured to emit essentially the same spectrum of light, or the array may be a multicolor array comprising LEDs configured to emit different colors of light.

The individual LEDs in an array may be individually operable (addressable) and/or may be operable as part of a group or subset of (e.g., adjacent) LEDs in the array.

An array of LEDs, or portions of such an array, may be formed as a segmented monolithic structure in which individual LEDs are electrically isolated from each other by trenches in a semiconductor diode structure and, optionally, insulating material in the trenches, but the electrically isolated segments remain physically connected to each other by other portions of the semiconductor diode structure.

An LED array may therefore be or comprise a monolithic multicolor matrix of individually operable LED light emitters. The LEDs in the monolithic array may for example be microLEDs as described above.

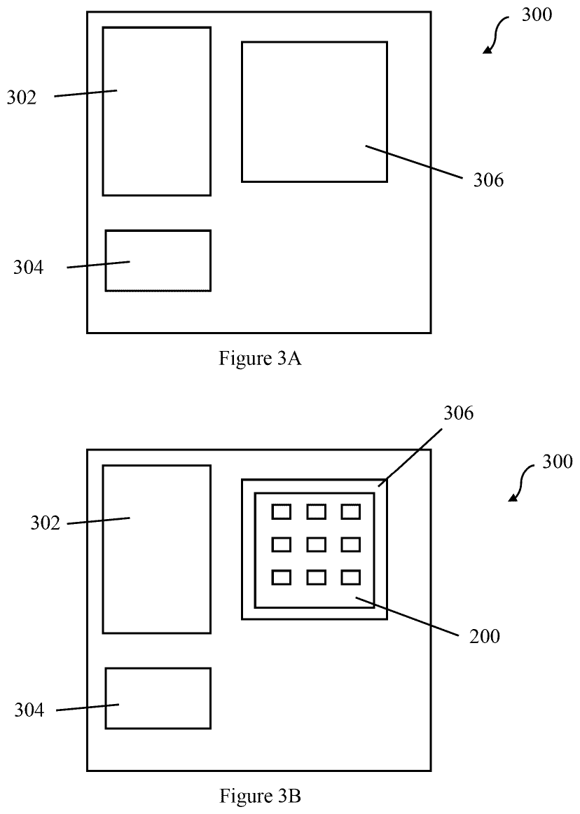

As shown in FIGS. 3A-3B, an LED array 200 may be mounted on an electronics board 300 comprising a power and control (and optionally, processor) module 302, an external input module 304, and an attach region 306. Power and control module 302 may receive power and control signals from external sources and signals from external input module 304, based on which power and control module 302 controls operation of the LEDs. A processor in module 302 may monitor and determine changes in operating conditions of the LEDs such as, for example, their current-voltage performance. External input module 304 may receive signals from temperature sensors, for example. Alternatively, array 200 may be mounted on a separate board (not shown) from the power and control module and the sensor module.

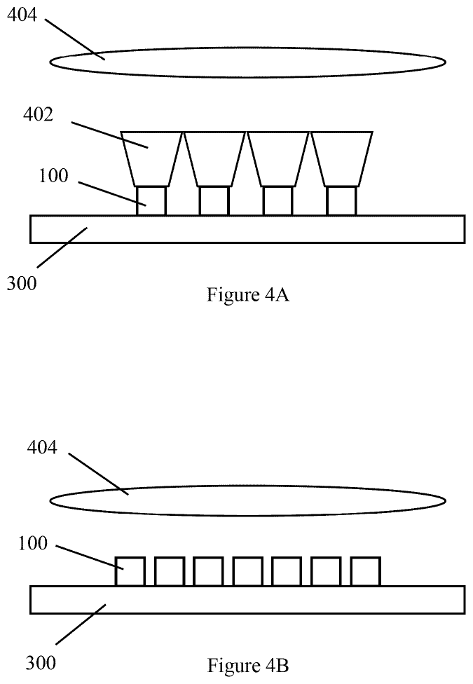

Individual LEDs may optionally incorporate or be arranged in combination with a lens or other optical element located adjacent to or disposed on the LED. Such an optical element, not shown in the figures, may be referred to as a “primary optical element”. In addition, as shown in FIGS. 4A-4B an array 200 (for example, mounted on an electronics board 300) may be arranged in combination with secondary optical elements such as waveguides, lenses, or both for use in an intended application. In FIG. 4A, light emitted by LEDs 100 is collected by waveguides 402 and directed to lens 404. Lens 404 may be a Fresnel lens, for example. In FIG. 4B, light emitted by LEDs 100 is collected directly by lens 404 without use of intervening waveguides. This arrangement may be particularly suitable when LEDs can be spaced sufficiently close to each other.

In another example arrangement, a central block of LEDs in an array may be associated with a single common (shared) optic, and edge LEDs located in the array at the periphery of the central bloc are each associated with a corresponding individual optic.

Generally, any suitable arrangement of optical elements may be used in combination with the LEDs and LED arrays described herein.

As summarized above, this specification discloses sensor systems and methods that employ an LED as both a light emitter and a light detector. Examples of such systems and methods are described next.

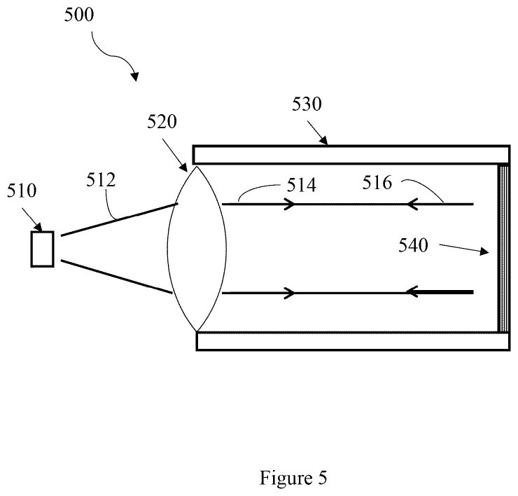

FIG. 5 illustrates an example sensor system 500 that includes an LED sensor 510 that both emits and detects light 512. Primary or secondary optics 520 can be used to direct light 514 to pass through a chamber 530 that includes fluid borne particles that need to be detected or have particle density quantified. Light passing through chamber 530 strikes a mirror 540 and can be back reflected (light 516) through the chamber 530 and optics 520 to be detected by the LED sensor 510.

In operation, particle detection is based on changes to current and voltage (IV) characteristics when it receives back reflected or back scattered light. The strength of returning light to the LED sensor 510 is a function of gas or particulate density in the optical path through chamber 530. Effectively, based on differences in particle density, there is a measurable current change upon minor on (strong reflection leading to increased current) and off (no reflection leading to reduced current). Signal detection can be either through constant voltage driven LED sensors (i.e. current detection), or through constant current driven LED sensors (i.e. voltage detection), and may be done with any suitable processor as noted above.

The LED sensor 510 may be any suitable single LED or LED array as described above, for example. Preferably, the LED or LEDs are direct-emitting LEDs with output wavelength determined by the semiconductor composition in the active region of the LED, rather than phosphor converted LEDs. This is because the phosphor layer in a phosphor converted LED may block scattered or reflected emission from reaching the active region of the LED and affecting its current-voltage performance.

In variations in which LED sensor 510 comprises two or more LEDs (e.g., an LED array) employed as light emitters and light detectors, changes to the current and voltage (IV) characteristics of each of the LEDs may be determined.

In some variations in which LED sensor comprises at least a first and a second LED, and the first LED may be arranged to detect a portion of light emitted by the second LED that is scattered or reflected to the first LED. The second LED may for example be configured to emit amplitude modulated light, and an amplitude modulated signal from the first LED, resulting from the portions of the light emitted by the second LED that are scattered or reflected to the first LED, may be detected. Such a modulation scheme may in some variations be used to improve signal/noise and detection sensitivity.

Any suitable optical arrangement (as described above, for example) may be used for optical element 520.

In some embodiments, chamber 530 can be open to the environment, while in other embodiments it can be closed. For example, in some embodiments, the chamber can be used for structural support purposes, holding the LED sensor 510, optics 520, and mirror 540 in a fixed position. This is particularly useful for embodiments intended to measure particle density in ambient atmosphere or a body of water (e.g. sea or river water). In other embodiments, the chamber can be sealed and connected to inflow or outflow systems for fluids. This can be useful for pipeline or other sealed flow systems.

In some embodiments, mirror 540 can be a flat, curved, or optically corrected reflective surface. Mirrors can be applied to a whole or a portion of the surface of the chamber. In some embodiments, the mirror can be positioned to contact a transparent surface, wall, or window in the chamber 530. Mirrors can be formed from reflective metals such as aluminum, silver, or gold, or in other embodiments formed from structured layers of dielectric materials. One or more mirrors can be used.

In some variations, internal surfaces of chamber 530 other than mirror 540 are light absorbing (e.g., black).

In some variations mirror 540 may be replaced with a scattering (rather than specularly reflective) surface. In some variations mirror 540 may be replaced with a light absorbing surface. In some variations mirror 540 may be replaced with a patterned (e.g., ruled or checkerboard) surface having reflective, scattering, and/or absorbing portions. In some variations, mirror 540 is replaced with a light absorbing surface and all other internal surfaces of the chamber are also light absorbing.

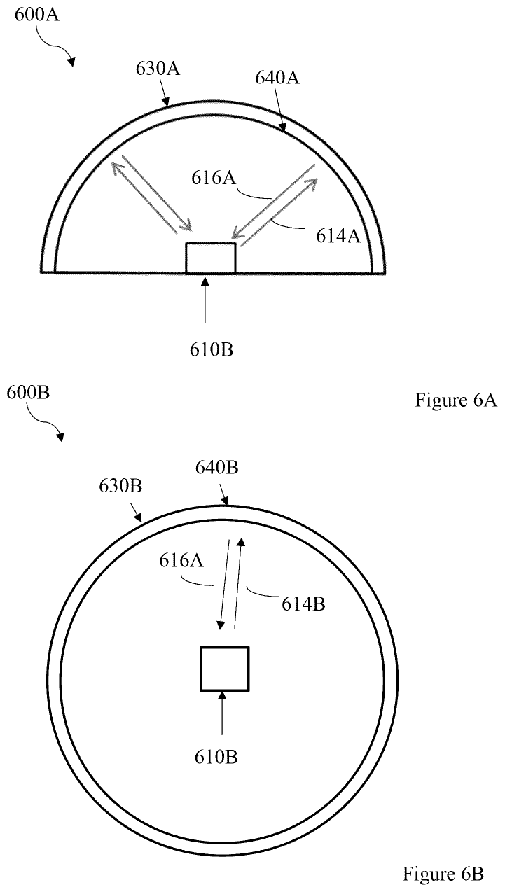

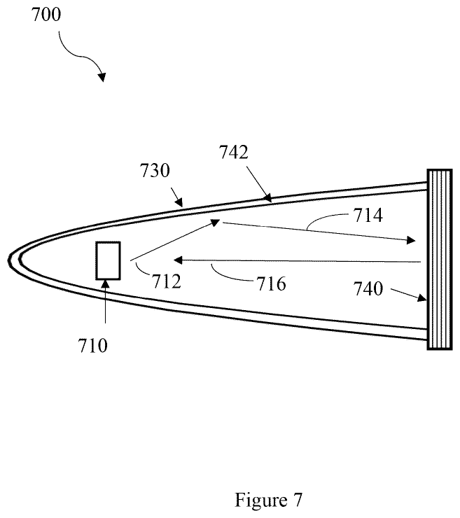

The example sensor systems illustrated in FIGS. 6A, 6B, and 7, described next, are similar to the example sensor system 500 of FIG. 5. They differ primarily in the internal shape of the chamber. These examples may be varied similarly to the variations of sensor system 500 described above.

FIG. 6A illustrates an LED sensor that both emits and detects light passing through a hemispherical chamber. Sensor system 600A includes LED sensor 610A that both emits and detects light. Light 614A is directed to pass through a hemispherical chamber 630A that includes fluid borne particles that need to be detected or have particle density quantified. Light passing through the chamber 630A strikes a mirror 640A on the inside of chamber and can be back reflected (light 616A) through the chamber 630A to be detected by the LED sensor 610A. While in this embodiment the mirror 640A is shown to be inside the chamber, in other embodiments the chamber wall can be transparent and the mirror 640A positioned outside the chamber.

FIG. 6B illustrates an LED sensor that both emits and detects light passing through a spherical chamber. Sensor system 600B includes LED sensor 610B that both emits and detects light. Light 614B is directed to pass through a hemispherical chamber 630B that includes fluid borne particles that need to be detected or have particle density quantified. Light passing through the chamber 630B strikes a minor 640B on the inside of chamber and can be back reflected (light 616B) through the chamber 630B to be detected by the LED sensor 610B. While in this embodiment the minor 640B is shown to be positioned outside the chamber on transparent chamber walls, in other embodiments the minor 640B can be positioned inside the chamber.

FIG. 7 illustrates an LED sensor that both emits and detects light passing through a parabolic chamber. Sensor system 700 includes LED sensor 710 that both emits and detects light. Light 714 is directed to pass through a parabolic chamber 730 that includes fluid borne particles that need to be detected or have particle density quantified. Light passing through chamber 730 strikes a parabolic mirror 742 and planar minor 740 on the inside of chamber and can be back reflected (light 716) through the chamber 730 to be detected by the LED sensor 710. While in this embodiment the mirrors 742 and 740 are shown to be inside the parabolic chamber 730, in other embodiments the chamber wall can be transparent and the mirror 742 and 740 can be positioned outside the chamber.

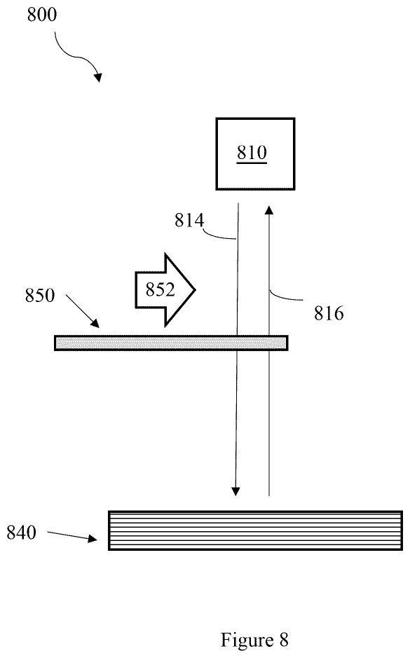

FIG. 8 illustrates a sensor system 800 that includes an LED sensor 810 that both emits (arrow 814) and detects light (light 816) returned or back reflected from a mirror 840 to provide low-cost identification of sensor occlusion by a moving object. For example, if a large object 850 (e.g. piece of paper) is moved in direction 852 to an intermediate or blocking position between the LED sensor 810 and minor 840, changes in detected current or voltage by LED sensor 810 can be used to identify absence or presence of the object. Sensor system 800 may be varied similarly to sensor system 500 described above.

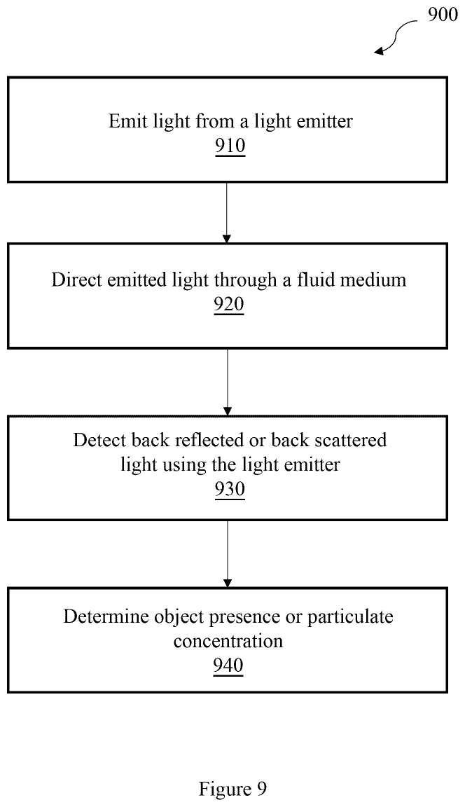

FIG. 9 illustrates operation 900 of a sensing system using an LED sensor that both emits and detects light passing through a chamber. In step 910, light is emitted from a light emitter. In step 920, emitted light is directed through a fluid medium that can contain particles or other objects. Back reflected light is detected by the light emitter/sensor (step 930), and object presence or particulate concentration is determined (step 940).

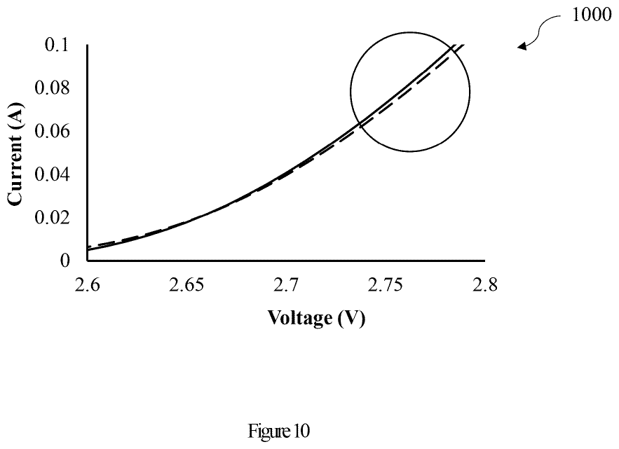

FIG. 10 is a graph 1000 showing LED sensor sensitivity to detected blue light. This graph shows the difference between an IV curve (broken line) for dark detection (no scattered or reflected light reaching the LED) and an IV curve (solid line) for the case in which reflected or scattered blue light is detected. Changes in the difference between these curves with varying amounts of scattered or reflected light detection may, for example, be calibrated to provide qualitative, semi-quantitative, or quantitative particle density detection. The circled high current high voltage portion of this curve may provide greatest sensitivity.

This disclosure is illustrative and not limiting. Further modifications will be apparent to one skilled in the art in light of this disclosure and are intended to fall within the scope of the appended claims.

What is claimed is:

1. A sensor system comprising:
a scattering or reflective surface;
an LED arranged to emit light toward the scattering or reflective surface and to detect a portion of the emitted light that is scattered or reflected back to the LED by the scattering or reflective surface; and
a processor configured to determine a change in voltage-current characteristics of the LED resulting from a change in an amount of the scattered or reflected light detected by the LED.

2. The sensor system of claim 1, wherein:
the LED is one of two or more LEDs in an LED array, each of the two or more LEDs arranged to emit light and to detect a portion of the light it emitted that is scattered or reflected back to it by the scattering or reflective surface; and
the processor is configured to determine a change in voltage-current characteristics for each of the LEDs resulting from a change in an amount of the scattered or reflected light detected by the LED.

3. The sensor system of claim 1, comprising a second LED, wherein the LED is arranged to detect a portion of light emitted by the second LED that is scattered or reflected to the LED by the scattering or reflective surface.

4. The sensor system of claim 3, wherein:
the second LED is configured to emit amplitude modulated light; and
the processor is configured to detect an amplitude modulated signal from the LED resulting from the portions of the light emitted by the second LED and scattered or reflected to the LED by the scattering or reflective surface.

5. The sensor system of claim 1, comprising an optical element arranged to collimate the light emitted by the LED toward the scattering or reflective surface.

6. The sensor system of claim 1, wherein:
the LED is arranged to emit light into a chamber and to detect a portion of the light emitted into the chamber that is scattered or reflected back through the chamber to the LED by the scattering or reflective surface; and
the processor is configured to determine properties of light scattering particles in a fluid in the chamber from the change in voltage-current characteristics of the LED.

7. The sensor system of claim 6, wherein:
the LED is one of two or more LEDs in an LED array, each of the two or more LEDs arranged to emit light into the chamber and to detect a portion of the light emitted into the chamber that is scattered or reflected back through the chamber to the LED by the scattering or reflective surface; and
the processor is configured to determine a change in voltage-current characteristics for each of the LEDs resulting from a change in an amount of the scattered or reflected light detected by the LED and to determine the properties of the light scattering particles in the fluid from the changes in voltage-current characteristics.

8. The sensor system of claim 6, wherein the scattering or reflective surface is a reflective surface forming at least a portion of an inner surface of the chamber.

9. The sensor system of claim 6, wherein at least a portion an inner surface of the chamber is configured to absorb light emitted by the LED into the chamber.

10. The sensor system of claim 6, comprising an optical element arranged to collimate the light emitted by the LED into the chamber.

11. The sensor system of claim 10, wherein the scattering or reflective surface is a reflective surface forming at least a portion of an inner surface of the chamber and arranged to reflect the collimated light back through the optical element to the LED.

12. The sensor system of claim 6, wherein the chamber is hemispherical.

13. The sensor system of claim 6, wherein the chamber is spherical.

14. The sensor system of claim 6, wherein the chamber is parabolic and is at least partially mirrored.

15. The sensor system of claim 6, wherein the chamber is open to a surrounding environment.

16. The sensor system of claim 6, wherein the chamber is closed with respect to a surrounding environment.

17. A sensing method comprising:
detecting with an LED light emitted by the LED toward a scattering or reflective surface and scattered or reflected back to the LED by the scattering or reflective surface, the scattering or reflective surface fixed in position with respect to the LED; and
determining a change in voltage-current characteristics of the LED resulting from a change in an amount of the scattered or reflected light detected by the LED.

18. The sensing method of claim 17, comprising determining properties of light scattering particles in a fluid through which the LED light is emitted toward the scattering or reflective surface from the change in voltage-current characteristics of the LED.

19. The sensing method of claim 17, comprising determining the presence or absence of an object located between the LED and the reflective or scattering surface from the change in voltage-current characteristics of the LED.

20. The method of claim 17, comprising collimating the light emitted by the LED before it is scattered or reflected back to the LED by the scattering or reflective surface.
